(19) United States
(12) Patent Application Publication
(10) Pub. No.: US 2026/0225832 A1
(43) Pub. Date: Aug. 6, 2026

(54) PALLETIZING SYSTEM AND METHOD

(71) Applicant: Brenton LLC, Alexandria, MN (US)

(72) Inventors: Michael R. GRINAGER, Miltona, MN (US); Samuel D. WELLER, Fergus Falls, MN (US)

(21) Appl. No.: 19/045,337

(22) Filed: Feb. 4, 2025

(51) Int. Cl. B65G 57/30; B65G 13/07; B65G 61/00

(52) U.S. Cl. CPC B65G 57/303; B65G 13/07; B65G 61/00

(57) ABSTRACT

A palletizing system for products includes a lower layer collection unit including first and second sets of rollers, and an overhead layer picking unit includes third and fourth sets of rollers. A roller drive system includes at least one movable belt. The lower layer collection unit includes a frame structure carrying the first set of rollers and the second set of rollers. The frame structure is movable between a lowered position and a raised position. When the first and second roller sets are in product load positions and the frame structure is in the lowered position, the first and second roller sets contact the at least one movable belt. When the first and second sets of rollers are in the product load positions and the frame structure is in the raised position, the first and second roller sets are moved out of contact with the at least one movable belt.

### TECHNICAL FIELD

This application relates generally to palletization of products in a layered manner and, more specifically, to a palletization system and method that involves the utilizes slidable roller surfaces.

### BACKGROUND

U.S. Pat. No. 7,581,919 discloses palletizing system that utilizes both a movable overhead unit with a sliding/movable roller support surface and a stationary lower unit with a sliding/movable roller support surface. Coordinated operation of the overhead and lower roller support surfaces enables the transfer of products layers from the lower unit to the overhead unit, so that the overhead unit can move the product layers to a pallet location.

It would be desirable to provide an improved implementation of such a palletizing system that enhances the palletization operation.

### SUMMARY

In one aspect, a palletizing system for products includes a lower layer collection unit including a first set of rollers and a second set of rollers, wherein the first set of rollers and the second set of rollers are movable between respective product load positions and product unload positions, wherein, in the product load positions the first set of rollers and the second set of rollers align in a product layer collection plane to define a product layer collecting surface, wherein, in the product unload positions the first set of rollers and the second set of rollers are moved out of the product layer collection plane. An overhead layer picking unit includes a third set of rollers and a fourth set of rollers, wherein the third set of rollers and the fourth set of rollers are movable between respective product lift positions and product window defining positions, wherein, in the product lift positions, the third set of rollers and the fourth set of rollers align in a product layer lift plane to define a product layer lift surface, wherein, in the product window defining positions, the third set of rollers and the fourth set of rollers are moved out of the product layer lift plane. A roller drive system includes at least one movable belt. The lower layer collection unit includes a frame structure carrying the first set of rollers and the second set of rollers. The frame structure is movable between a lowered position and a raised position. When the first set of rollers and the second set of rollers are in the product load positions and the frame structure is in the lowered position, the first set of rollers and the second set of rollers are selectively rotatable about their axes via contact with the at least one movable belt. When the first set of rollers and the second set of rollers are in the product load positions and the frame structure is in the raised position, the first set of rollers and the second set of rollers are moved out of contact with the at least one movable belt.

In another aspect, a palletizing system for products includes a lower layer collection unit including a first set of rollers and a second set of rollers, wherein the first set of rollers and the second set of rollers are movable between respective product load positions and product unload positions, wherein, in the product load positions the first set of rollers and the second set of rollers align in a product layer collection plane to define a product layer collecting surface, wherein, in the product unload positions the first set of rollers and the second set of rollers are moved out of the product layer collection plane. An overhead layer picking unit includes a third set of rollers and a fourth set of rollers, wherein the third set of rollers and the fourth set of rollers are movable between respective product lift positions and product window defining positions, wherein, in the product lift positions, the third set of rollers and the fourth set of rollers align in a product layer lift plane to define a product layer lift surface, wherein, in the product window defining positions, the third set of rollers and the fourth set of rollers are moved out of the product layer lift plane, wherein the overhead layer picking unit is movable between a lowered position and a raised position relative to the lower layer collection unit. A roller drive system includes at least one movable drive belt. The first set of rollers and second set of rollers are movable between a lowered drive belt engaging position and a raised belt non-engaging position spaced away from the at least one drive belt. A control system is configured for controlling operation of the lower layer collection unit, the overhead layer picking unit, and the roller drive system, and the control system is configured such that: with the overhead layer picking unit in its raised position and the first set of rollers and the second set of rollers in the product load positions and in the lowered drive belt engaging position, products are moved onto the layer collecting surface while the roller drive system rotates the first set of rollers and the second set of rollers in a direction to move the products away from the staging conveyor to a stop position on the layer collecting surface; and after the products reach the stop position, the first set of rollers and the second set of rollers are moved to the raised belt non-engaging position to move the first set of rollers and the second set of rollers out of contact with the at least one belt.

In a further aspect, a method of moving a layer of product in a palletizing operation involves: moving product from a staging conveyor onto a lower layer collection unit including a first set of rollers and a second set of rollers, wherein the first set of rollers and the second set of rollers are located in product load positions in which the first set of rollers and the second set of rollers are aligned in a product layer collection plane to define a product layer collecting surface onto which the product is moved; shifting the product layer collection plane upward; moving an overhead layer picking unit down over the product layer collection plane, wherein the overhead layer picking unit includes a third set of rollers and a fourth set of rollers in product window defining positions; and transferring the product from support by the first set of rollers and the second set of rollers to support by the third set of rollers and the fourth set of rollers by simultaneously (i) shifting the first set of rollers and the second set of rollers from the product load positions to product unload positions and (ii) shifting the third set of rollers and the fourth set of rollers from the product window defining positions to product lift positions in which the third set of rollers and the fourth set of rollers align in a product layer lift plane to define a product layer lift surface beneath and supporting the products.

The details of one or more embodiments are set forth in the accompanying drawings and the description below. Other features, products, and advantages will be apparent from the description and drawings, and from the claims.

### BRIEF DESCRIPTION OF THE DRAWINGS

FIGS. 1-2 show perspective views of a palletizing system;

FIG. 3 shows a side view of the palletizing system;

FIG. 4 shows a perspective view of portions of the palletizing system;

FIGS. 5 and 6 show perspective views of the overhead layer picking unit of the palletizing system; and

FIGS. 7-19 show side elevation schematic views of a sequence of operation of the palletizing system.

### DETAILED DESCRIPTION

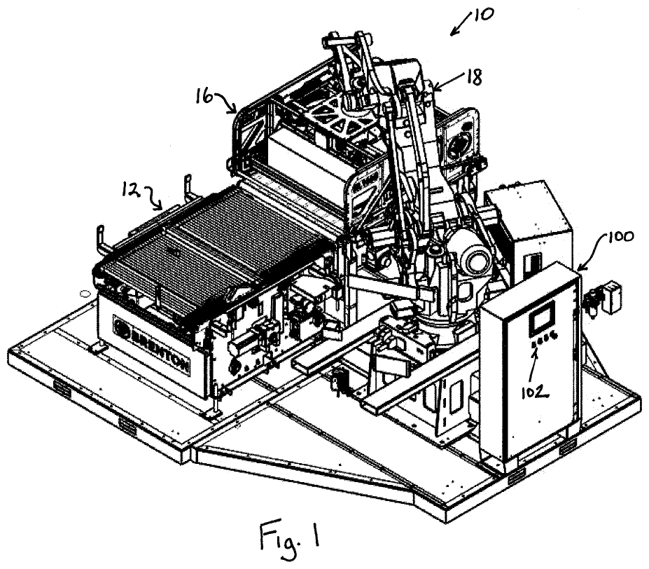

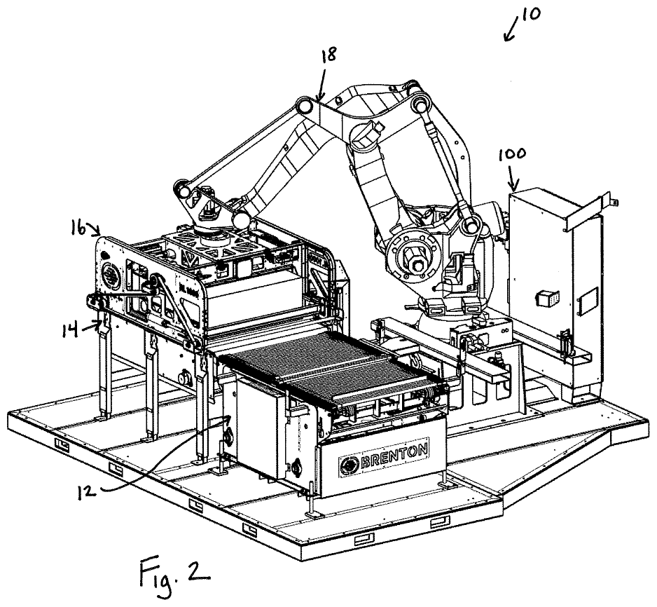

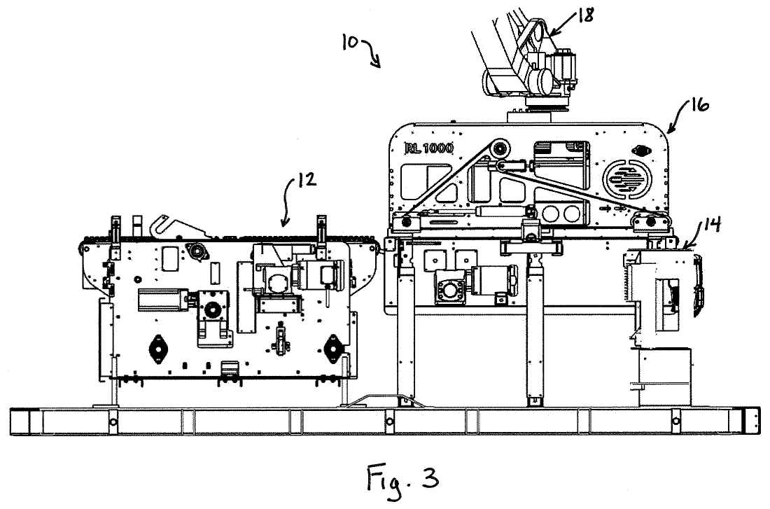

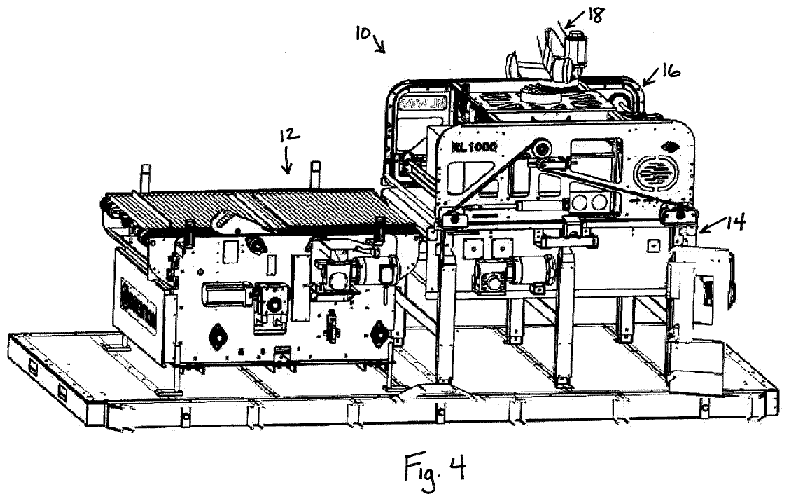

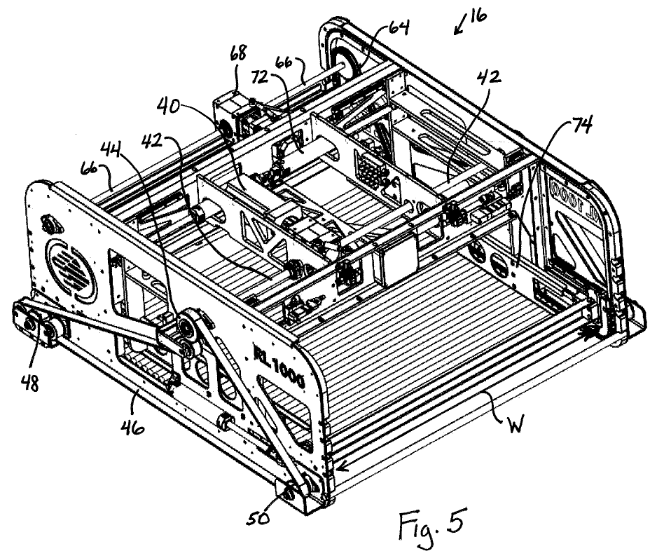

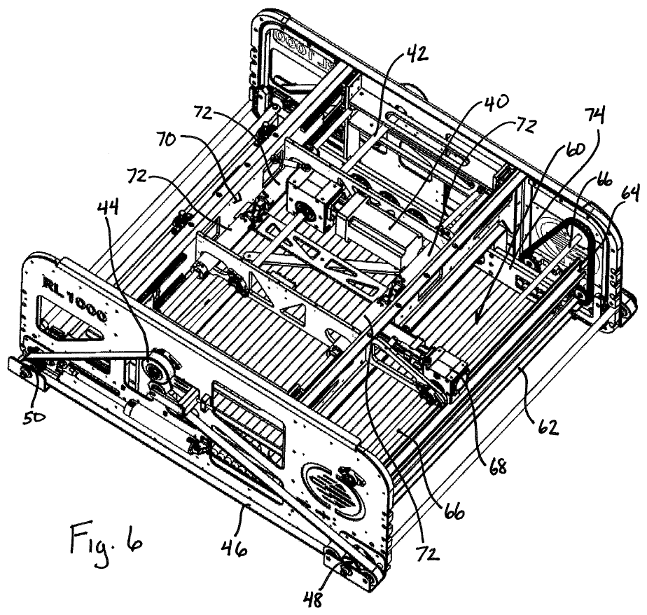

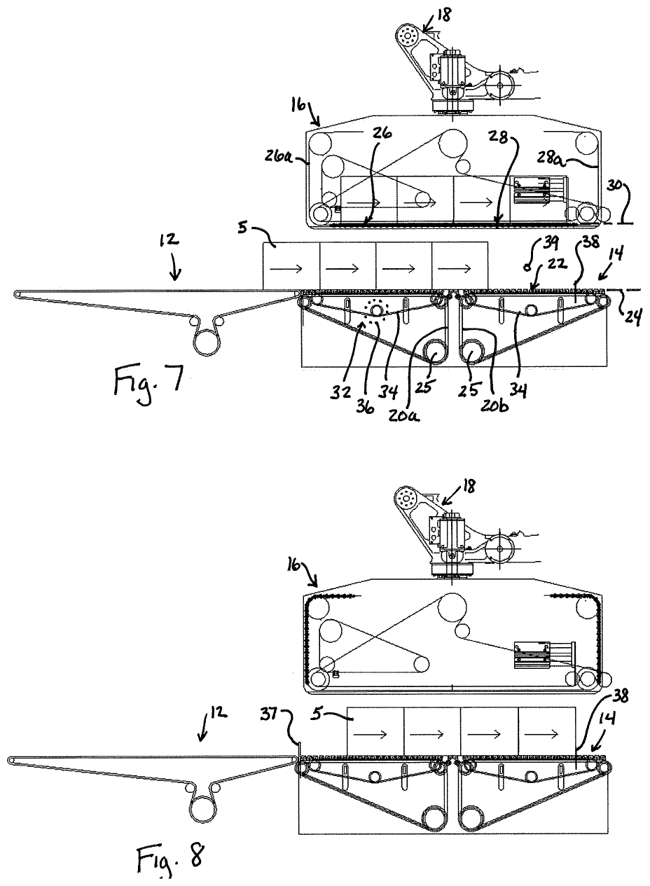

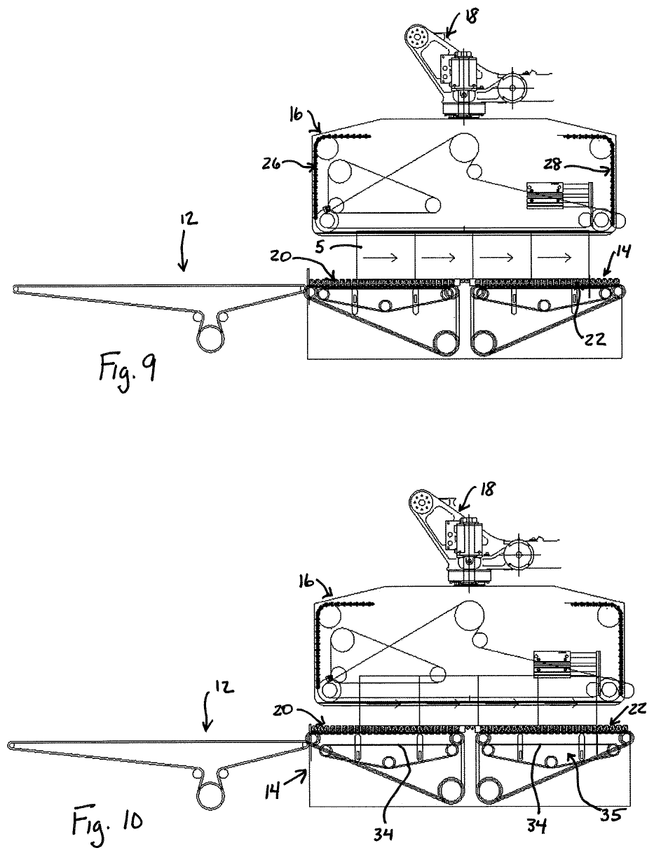

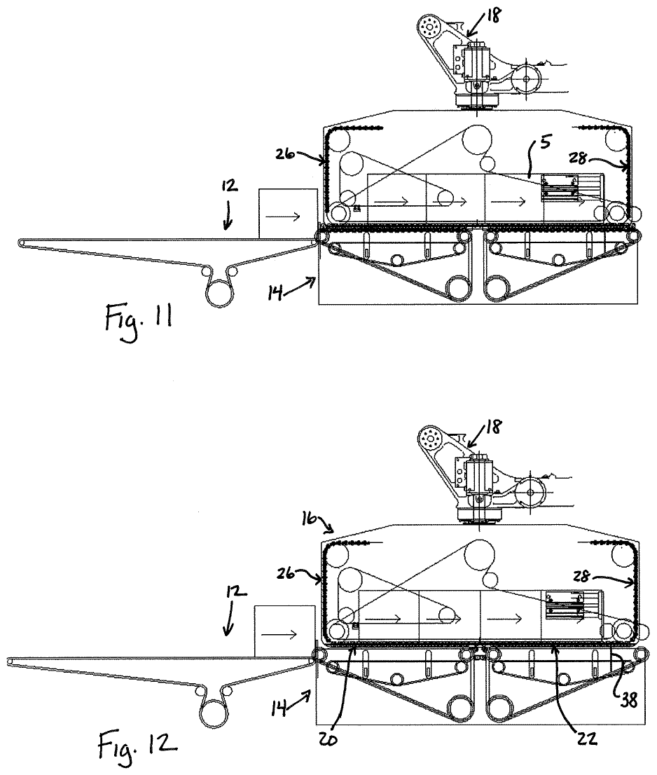

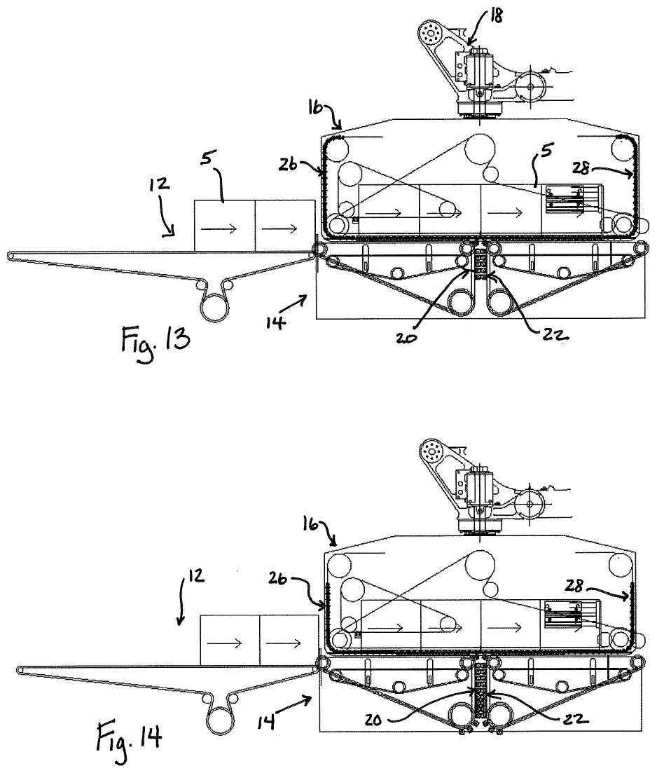

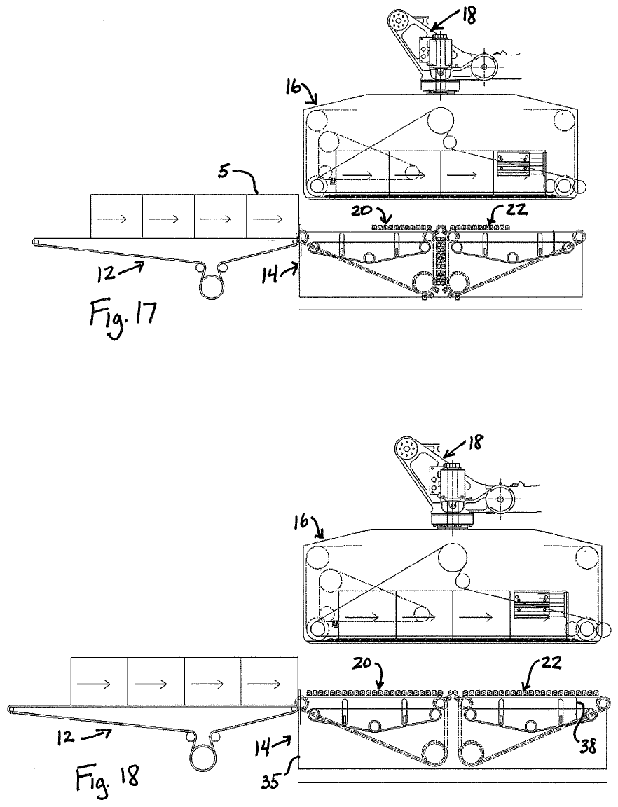

Referring to FIGS. 1-19, a palletizing system 10 for products 5 is shown and includes a staging conveyor 12, a lower layer collection unit 14 and an overhead layer picking unit 16 at the end of a robotic arm 18.

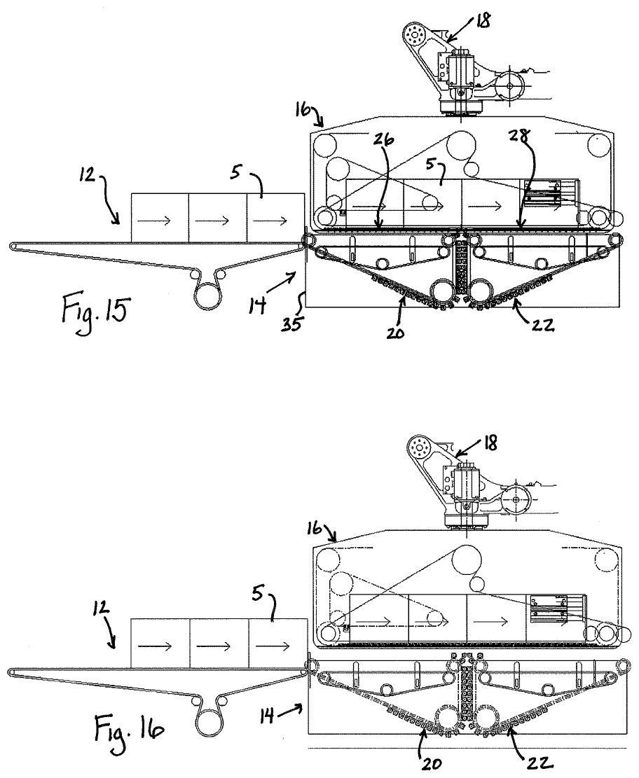

The lower layer collection unit 14 includes two sets of rollers 20 and 22. The axial ends of the rollers of each set of rollers 20, 22 are engaged to ride in respective tracks 20a, 20b that enable that enable movement of the roller sets 20 and 22 between respective product load positions (FIG. 7) and product unload positions (FIG. 15). In the product load positions, the roller sets 20 and 22 align in a product layer collection plane 24 to define a product layer collecting surface, and in the product unload positions the roller sets are moved out of the product layer collection plane 24. The roller sets 20 and 22 are linked to respective chains, belts or cable arrangements that move the roller sets. Here, a motor or motors 25 are provided to move the roller sets 20 and 22 along the tracks by any suitable interconnection to the roller sets.

The overhead layer picking unit 16 includes two sets of rollers 26 and 28. The axial ends of the rollers of each set of rollers roller sets 26 and 28 are engaged to ride in respective tracks 26a, 28a that enable movement of the roller sets 26 and 28 between respective product lift positions (FIG. 15) and product window defining positions (FIG. 8). In the product lift positions, the roller sets 26 and 28 align in a product layer lift plane 30 to define a product layer lift surface, and in the product window defining positions, the roller sets 26 and 28 are moved out of the product layer lift plane 30. Here, a motor 40 is provided to control movement of the roller sets 26 and 28, via rotation of a drive shaft 42 that rotates drive wheels 44 of side belts 46 that, in turn, drive pulleys 48 and 50 that move the respective roller sets 26 and 28 (e.g., the drive pulleys 48 and 50 rotate sprockets that drive chains that are linked to the roller sets 26 and 28).

A roller drive system 32 is included below the roller sets 20 and 22, and may be formed by one or mor belts 34 that are drivable by a motor 36. The lower layer collection unit 14 includes a frame structure 35 carrying the tracks 20a and 20b and the roller sets 20 and 22, and the frame structure is movable between a lowered position (FIG. 8) and a raised position (FIG. 10). Such movement may be via one or more motors or one or more linear actuators. When the roller sets 20 and 22 are in their product load positions and the frame structure is in the lowered position, the roller sets are selectively rotatable about their axes via contact with the movable belt(s) 34 (i.e., movement of the belt(s) 34 will rotate the rollers). When the roller sets 20 and 22 are in their product load positions and the frame structure is in the raised position, the roller sets 20 and 22 are moved out of contact with the movable belt(s) 34 (i.e., movement of the belt(s) 34 will no longer cause movement of the rollers, and the roller sets 20 and 22 are free to be moved from the product load positions to the product unload positions, and vice versa, without interference from the belt(s) 34).

The lower layer collection unit 14 includes an end stop plate 38 that extends upward through roller set 22 when the roller sets 20 and 22 are in their product load positions and the frame structure is in its lowered position. The lower layer collection unit also includes one or more product sensor(s) 39 for detection of products as they are moved onto the product layer collecting surface defined by the roller sets 20 and 22.

The overhead layer picking unit 16 includes an actuatable squaring system 70 and an actuatable centering pusher 60. Here, the centering pusher 60 includes a pusher plate 62 that is linked at opposite ends to respective belts or chains 64 that are driven by shafts 66 that are rotatably vis a motor 68. Here, the centering system 70 includes a set of linear actuators 72 (e.g., air cylinders) that can be actuated to move side plates 74 inward and outward along a width W of the support surface formed by the roller sets 26 and 28.

A control system 100 is provided and is configured for controlling operation of the staging conveyor 12, the lower layer collection unit 14, the overhead layer picking unit 16, the roller drive system 32 and the robotic arm 18. As used herein, the term control system is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group-including hardware or software that executes code), software, firmware and/or other electrical or electronic components, or a combination of some or all of the above, that carries out the control functions of the device or the control functions of any component thereof. Here, the control system 100 includes an associated user interface 102.

The control system 100 is configured such that, with the overhead layer picking unit 6 and the frame structure in the lowered position and the roller sets 20 and 22 in the product load positions, products are moved from the staging conveyor 12 onto the layer collecting surface while the roller drive system 32 rotates the roller sets 20 and 22 in a direction to move the products away from the staging conveyor 12 to a stop position on the layer collecting surface, where the stop position is defined by the end stop plate 38 (see FIGS. 7-8). After the correct product load is transitioned from the staging conveyor 12 onto the roller sets 20 and 22, a front stop plate 37 is raised to prevent any further product from moving from the staging conveyor onto the roller sets 20 and 22 (see FIG. 8).

After the products reach the stop position, the frame structure 35 is moved to the raised position to move the roller sets 20 and 22 out of contact with the belt(s) 34 (see FIGS. 9-10). At the same time, the rollers are moved higher than the top of the stop plate 38 such that the stop plate will not interfere with shifting of the roller sets 20 and 22 from the product load position to the product unload positions.

With the roller sets 26 and 28 in their product window defining positions and the frame structure 35 in the raised position, the overhead layer picking unit 16 is moved (via the robotic arm 18) to the layer pick position (see FIG. 11).

The roller sets 20 and 22 are then moved toward their product unload positions simultaneously with the roller sets 26 and 28 being moved into their product lift positions beneath the products such that transfer of support of the products from the roller sets 20 and 22 to the roller sets 26 and 28 takes place (see FIGS. 12-15).

The control system 100 is also configured such that, after the overhead layer picking unit 18 is moved to the layer pick position, the squaring system 70 is actuated to square the products and the centering pusher 60 is actuated to shift the products into a position centered relative to the overhead layer picking unit (see FIGS. 11-12). This occurs prior to transfer of product support from the roller sets 20 and 22 to the roller sets 26 and 28.

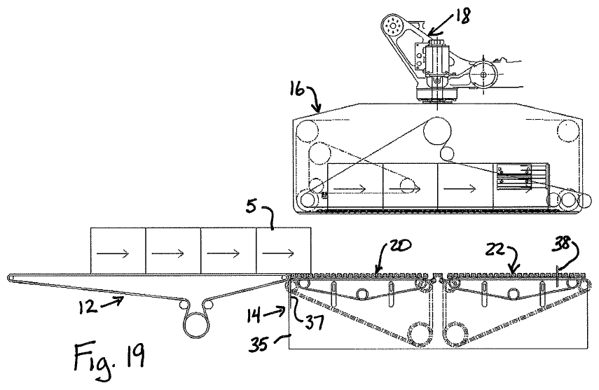

After transfer of the products 5 from the lower layer collection unit 14 to the overhead layer picking unit 18, the overhead layer picking unit is raised to move the products to a palletizing location, the roller sets 20 and 22 are returned to their product load positions (FIGS. 16-18) and then the roller sets 20 and 22 are lowered back into position to place the roller sets 20 and 22 into alignment to received further product from the staging conveyor 12 and the front stop plate 37 is also lowered (see transition from FIG. 18 to FIG. 19).

Thus, the palletizing system provides a unique operation and method to facilitate the transition of a full product layer from the lower layer collection unit to the overhead layer picking unit, as described in more detail below.

S1. Product Flow onto the lower layer collection unit 14: The product is transferred from the staging conveyor 12 onto the roller sets 20 and 22 of the lower layer collection unit. This movement may be driven by one or more AC motor-powered belts 34 located beneath the rollers or the roller sets 20 and 22, which turn the rollers in the required direction to move the product across the unit as the rollers are in contact with the drive belts.

S2. Deceleration and Positioning: As the product approaches the end of the lower layer collection unit, a sensor 39 detects its presence, prompting the AC motor to decelerate the rotation of the rollers of the roller sets. Then the belt-drive motor stops as the product contacts the fixed end stop 38, ensuring proper product positioning.

S3. Roller Actuation for Clearance: The roller assembly lifts (e.g., frame structure of the rollers lifts approximately 3 inches) such that the rollers of roller set 22 clear the fixed end stop 38. This movement creates space for roller sets 20 and 22 to retract to the product unload position in preparation for the next step.

S4. Roller Positioning for Interaction With Overhead Unit: The servo-driven lower roller sets 20 and 22, controlled by a precise servo motor, reposition themselves to align with the overhead layer picking unit (see the movement of roller sets 20 and 22 between the position of FIG. 11 and the position of FIG. 12). This ensures a seamless interaction between the roller sets 26 and 28 of the overhead unit 16 and the roller sets 20 and 22. At this stage, the product is ready to be picked up by the overhead unit 16.

S5. Overhead Unit Alignment and Positioning: The robotic arm 18 lowers the overhead layer picking unit 16 to the correct position for product transfer (See FIG. 11). Simultaneously, two air-cylinder-driven squaring devices 74 inside the overhead unit move into place. The servo-driven end stop 62 also activates, precisely aligning the product at the center of the tool (see transition from FIG. 11 to FIG. 12). This positioning ensures that the pick-and-drop sequence occurs without error.

S6. Synchronized Roller Set Motion: The servo-driven roller sets on both the lower layer collection unit 14 and the overhead layer picking unit 16 move in synchronization, with the roller sets 20 and 22 moving inward, down and then back outward as the roller sets 26 and 28 move down and inward toward each other to replace the roller sets 20 and 22. This synchronized motion uses minimal travel distance (e.g., less than 30 inches, such as approximately 24 inches on each side) and ensures smooth product transfer from the lower layer collection unit 14 to the overhead layer picking unit 16.

S7. Lifting and Transfer: Once the product 5 has been fully transferred from the lower layer collection unit 14 to the overhead layer picking unit 16, the robot 18 lifts the overhead layer picking unit 16, carrying away the product that was once on the lower layer collecting unit 14.

S8. Lower Unit Reset and Ready for Next Product: After the overhead layer picking unit 16 clears the lower layer collecting unit 14, the retracted roller sets 20 and 22 are returned to their original, product load positions. The roller sets 20 and 22 then lower back to the starting position, ready to receive additional products from the staging conveyor 12.

S9. Final Product Transfer to a Palletizing Location: The robot 18 then moves the product 5 to a pallet location to stack the layer or product onto the pallet or onto a prior layer on the pallet. For this purpose, the servo-driven roller sets 26 and 28 retract to the product window defining positions, setting the product gently.

It is to be clearly understood that the above description is intended by way of illustration and example only, is not intended to be taken by way of limitation, and that other changes and modifications are possible.

1. A palletizing system for products, comprising:
a lower layer collection unit including a first set of rollers and a second set of rollers, wherein the first set of rollers and the second set of rollers are movable between respective product load positions and product unload positions, wherein, in the product load positions the first set of rollers and the second set of rollers align in a product layer collection plane to define a product layer collecting surface, wherein, in the product unload positions the first set of rollers and the second set of rollers are moved out of the product layer collection plane;
an overhead layer picking unit including a third set of rollers and a fourth set of rollers, wherein the third set of rollers and the fourth set of rollers are movable between respective product lift positions and product window defining positions, wherein, in the product lift positions, the third set of rollers and the fourth set of rollers align in a product layer lift plane to define a product layer lift surface, wherein, in the product window defining positions, the third set of rollers and the fourth set of rollers are moved out of the product layer lift plane;
a roller drive system comprising at least one movable belt;
wherein the lower layer collection unit includes a frame structure carrying the first set of rollers and the second set of rollers, wherein the frame structure is movable between a lowered position and a raised position;
wherein, when the first set of rollers and the second set of rollers are in the product load positions and the frame structure is in the lowered position, the first set of rollers and the second set of rollers are selectively rotatable about their axes via contact with the at least one movable belt;
wherein, when the first set of rollers and the second set of rollers are in the product load positions and the frame structure is in the raised position, the first set of rollers and the second set of rollers are moved out of contact with the at least one movable belt.

2. The system of claim 1, wherein the overhead layer picking unit is connected at an end of a robotic arm that is operable for moving the overhead layer picking unit from a layer pick position over the lower layer collection unit and at least a raised position out of the layer pick position.

3. The system of claim 2, further comprising:
a staging conveyor positioned alongside the lower layer collection unit and operable to feed products onto the layer collecting surface;
a control system configured for controlling operation of the staging conveyor, the lower layer collection unit, the overhead layer picking unit, the roller drive system and the robotic arm;
wherein the control system is configured such that:
with the overhead layer picking unit in its raised position and the frame structure in its lowered position and the first set of rollers and the second set of rollers in the product load positions, products are moved from the staging conveyor onto the layer collecting surface while the roller drive system rotates the first set of rollers and the second set of rollers in a direction to move the products away from the staging conveyor to a stop position on the layer collecting surface;
after the products reach the stop position, the frame structure is moved to the raised position to move the first set of rollers and the second set of rollers out of contact with the at least one belt;
with the third set of rollers and fourth set of rollers in the product window defining position and the frame structure in the raised position, the overhead layer picking unit is moved to the layer pick position;
the first set of rollers and the second set of rollers are moved toward the product unload positions simultaneously with the third set of rollers and the fourth set of rollers being moved into the product lift positions beneath the products such that transfer of support of the products from the first set of rollers and the second set of rollers to the third set of rollers and the fourth set of rollers takes place.

4. The system of claim 3, wherein:
the overhead layer picking unit includes an actuatable squaring system and an actuatable centering pusher;
the control system is configured such that, after the overhead layer picking unit is moved to the layer pick position, the squaring system is actuated to square the products and the centering pusher is actuated to shift the products into a position centered relative to the overhead layer picking unit.

5. A palletizing system for products, comprising:
a lower layer collection unit including a first set of rollers and a second set of rollers, wherein the first set of rollers and the second set of rollers are movable between respective product load positions and product unload positions, wherein, in the product load positions the first set of rollers and the second set of rollers align in a product layer collection plane to define a product layer collecting surface, wherein, in the product unload positions the first set of rollers and the second set of rollers are moved out of the product layer collection plane;
an overhead layer picking unit including a third set of rollers and a fourth set of rollers, wherein the third set of rollers and the fourth set of rollers are movable between respective product lift positions and product window defining positions, wherein, in the product lift positions, the third set of rollers and the fourth set of rollers align in a product layer lift plane to define a product layer lift surface, wherein, in the product window defining positions, the third set of rollers and the fourth set of rollers are moved out of the product layer lift plane, wherein the overhead layer picking unit is movable between a lowered position and a raised position relative to the lower layer collection unit;
a roller drive system comprising at least one movable drive belt, wherein the first set of rollers and second set of rollers are movable between a lowered drive belt engaging position and a raised belt non-engaging position spaced away from the at least one drive belt.
a control system configured for controlling operation of the lower layer collection unit, the overhead layer picking unit, and the roller drive system;
wherein the control system is configured such that:
with the overhead layer picking unit in its raised position and the first set of rollers and the second set of rollers in the product load positions and in the lowered drive belt engaging position, products are moved onto the layer collecting surface while the roller drive system rotates the first set of rollers and the second set of rollers in a direction to move the products away from the staging conveyor to a stop position on the layer collecting surface;
after the products reach the stop position, the first set of rollers and the second set of rollers are moved to the raised belt non-engaging position to move the first set of rollers and the second set of rollers out of contact with the at least one belt.

6. The system of claim 5, wherein the controller is configured such that:
with the third set of rollers and fourth set of rollers in the product window defining position and the first set of rollers and the second set of rollers in the raised belt non-engaging position, the overhead layer picking unit is moved to the layer pick position; and
the first set of rollers and the second set of rollers are moved toward the product unload positions simultaneously with the third set of rollers and the fourth set of rollers being moved into the product lift positions beneath the products such that transfer of support of the products from the first set of rollers and the second set of rollers to the third set of rollers and the fourth set of rollers takes place.

7. The system of claim 6, wherein:
the overhead layer picking unit includes an actuatable squaring system and an actuatable centering pusher; and
the control system is configured such that, after the overhead layer picking unit is moved to the layer pick position, the squaring system is actuated to square the products and the centering pusher is actuated to shift the products into a position centered relative to the overhead layer picking unit.

8. A method of moving a layer of product in a palletizing operation, the method comprising:
moving product from a staging conveyor onto a lower layer collection unit including a first set of rollers and a second set of rollers, wherein the first set of rollers and the second set of rollers are located in product load positions in which the first set of rollers and the second set of rollers are aligned in a product layer collection plane to define a product layer collecting surface onto which the product is moved;
shifting the product layer collection plane upward;
moving an overhead layer picking unit down over the product layer collection plane, wherein the overhead layer picking unit includes a third set of rollers and a fourth set of rollers in product window defining positions;
transferring the product from support by the first set of rollers and the second set of rollers to support by the third set of rollers and the fourth set of rollers by simultaneously (i) shifting the first set of rollers and the second set of rollers from the product load positions to product unload positions and (ii) shifting the third set of rollers and the fourth set of rollers from the product window defining positions to product lift positions in which the third set of rollers and the fourth set of rollers align in a product layer lift plane to define a product layer lift surface beneath and supporting the products.

9. The method of claim 8, wherein:
as the product is moved from the staging conveyor onto the product layer collecting surface, rollers of the first set of rollers and the second set of rollers are rotated by at least one belt contacting bottoms of the rollers;
when the product layer collection plane is shifted upward, the rollers of the first set of rollers and the second set of rollers are moved out of contact with the at least one belt.

10. The method of claim 9, wherein:
as the product is moved from the staging conveyor onto the product layer collecting surface, the lower layer collection unit includes an end stop extending upward between rollers of the second set of rollers;
when the product layer collection plane is shifted upward, the rollers of the second set of rollers are moved higher than a top of the end stop.

11. The method of claim 8, wherein:
after transferring the product from support by the first set of rollers and the second set of rollers to support by the third set of rollers and the fourth set of rollers:
moving the overhead layer picking unit away from the lower layer collection unit;
shifting the first set of rollers and the second set of rollers back to the product load positions and, thereafter, lowering the product layer collection plane back downward.
